(19) United States
(12) Patent Application Publication
(10) Pub. No.: US 2007/0199350 A1
(43) Pub. Date: Aug. 30, 2007

(54) Methods for producing glass compositions

(76) Inventors: Dennis I. Butts, Andover, NY (US); Jennifer B. Canary, Versailles, KY (US); Glen B. Cook, Elmira, NY (US); Philip M. Fenn, Corning, NY (US); J. Terry Fisk, Elmira Heights, NY (US); Sandra L. Gray, Horseheads, NY (US); James P. McCann, Horseheads, NY (US)

Correspondence Address: CORNING INCORPORATED, SP-TI-3-1, CORNING, NY, 14831, US

(21) Appl. No.: 11/704,809

(22) Filed: Feb. 9, 2007

Related U.S. Application Data
(60) Provisional application No. 60/776,482, filed on Feb. 24, 2006.

(51) Int. Cl. C03C 6/02; C03C 6/00

(52) U.S. Cl. 65/135.9; 501/27

(57) ABSTRACT

The subject matter disclosed herein generally relates to methods for producing glass compositions with a reduced number of defects.

### CROSS-REFERENCE TO RELATED APPLICATIONS

This application claims the benefit of U.S. Application Ser. No. 60/776,482 filed on Feb. 24, 2006 and entitled “Methods for Producing Glass Compositions” which is incorporated by reference herein in.

### FIELD

The subject matter disclosed herein generally relates to methods for producing glass compositions with a reduced number of defects.

### BACKGROUND

In typical conventional glass making processes, all raw materials are pretreated, mixed, optionally with water, to form a single melting batch, and then charged in installment or continuously into a premelter or a glass melting furnace, where the batch materials are subjected to heating and melting using fuel firing and/or electrical energy. A series of chemical reactions take place inside the premelter and/or furnace, whereby molten glass is formed. The molten glass is then allowed to exit the furnace and formed into glass sheets, tubes, fibers, containers, optical products, and the like, using various techniques and equipment.

During glass manufacturing, different types of defects can be produced. One such defect involves the production of seeds, which are derived from gasses present in the molten glass. Another defect is what is termed stones. Stones are generally solid inclusions that have not been fully digested or dissolved. The size and number of stones formed during glass formation can vary depending upon the selection of batch materials used to prepare the glass and processing conditions. For example, the stone can be composed of one or more batch materials that have not been completely digested. Alternatively, the term “stones” can include “knots.” Knots are silica inclusions in glass that are almost glassy in nature. In other words, knots are inclusions that are almost digested, but not completely digested. The presence of the above-identified defects during glass manufacturing is commercially relevant because if a significant amount of these impurities are present in the resultant glass article, the glass article can be rendered useless and ultimately discarded.

Thus, it would be desirable to have methods for producing glass compositions with fewer defects. It has been unexpectedly discovered that the selection of starting materials used to produce the glass can help reduce the number of defects, particularly stones, present in the glass. The methods described herein produce homogeneous, uniform glass, which is desirable in certain applications such as LCD substrates. The methods described herein satisfy these needs.

### SUMMARY

In accordance with the purposes of the disclosed materials, compounds, compositions, articles, devices, and methods, as embodied and broadly described herein, the disclosed subject matter, in one aspect, relates to methods for producing glass compositions with a reduced number of defects. Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 shows the number of defects (i.e., seeds and stones) for two glass compositions produced by with calcium borate (745 DDW) versus two glass compositions (745 AYB) not produced with calcium borate.

FIG. 2 shows the number of defects (i.e., seeds and stones) for two glass compositions produced with calcium borate (745 DDW) versus two glass compositions (745 AYB) not produced with calcium borate.

FIG. 3 shows the number of defects (i.e., seeds and stones) for glass compositions produced with calcium borate (745 DDY) and without calcium borate (745 AYB and 745 DDZ).

FIG. 4 shows the number of defects (i.e., seeds and stones) for glass compositions produced by with (745 DDY) and without (745 DDZ) calcium borate.

### DETAILED DESCRIPTION

The materials, compounds, compositions, articles, devices, and methods described herein may be understood more readily by reference to the following detailed description of specific aspects of the disclosed subject matter and the Examples included herein.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the layer” includes mixtures of two or more such layers, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application, data are provided in a number of different formats, and that this data, represent endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers or are prepared by methods known to those skilled in the art.

Also, disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed as well as a class of components D, E, and F and an example of a composition A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

Reference will now be made in detail to specific aspects of the disclosed materials, compounds, compositions, articles, and methods, examples of which are illustrated in the accompanying Examples.

The methods described herein are useful in producing glass compositions with reduced defects such as, for example, stones. In the past, the formation of stones has been associated with the silica (i.e., sand) source. In the case of stones, this would be expected, as stones are silica quartz crystals. However, what has been unexpectedly discovered is that the source of stone formation can be derived from other batch materials used to make the glass composition besides sand. The presence of single crystal quartz grains or refractory particles present in the batch materials can result in stone formation. For example, a typical component used to produce glass is mined limestone (i.e., calcium carbonate). It has been discovered that one drawback to using mined limestone is the presence of impurities such as, for example, quartz grains. Larger sized grains present in mined limestone do not necessarily melt during heating and, thus, form stones in the glass composition.

In view of the problems identified above with respect to stone formation in glass manufacturing, in one aspect, described herein are methods for producing a glass composition, comprising heating a mixture of glass precursor components for a sufficient time and temperature to melt the components to produce the glass composition, wherein one of the glass precursor components comprises a calcium source comprising (1) no single crystal quartz grains or refractory particles or (2) single crystal quartz grains or refractory particles having a particle size less than about 210 μm.

In this aspect, one of the glass precursor components is a calcium source comprising (1) no single crystal quartz grains or (2) refractory particles or quartz grains or refractory particles having a particle size less than about 210 μm. The term “refractory particle” is defined herein as a particle that is generally more resistant to melting when compared to the batch material. The refractory particles can be derived from contaminants present in the batch materials. Examples of refractory materials include, but are not limited to, chromite and corundum.

The term “calcium source” is any compound that contains calcium and will incorporate calcium into the final glass composition after processing. It is contemplated that the calcium source can be synthesized or purified using techniques known in the art. Alternatively, the calcium source can be obtained from natural sources and used as is. In one aspect, the calcium source comprises a calcium salt, oxide, or a mixture thereof. In another aspect, the calcium source comprises calcium hydroxide, calcium carbonate, calcium oxide, calcium nitrate, calcium chloride, or any combination thereof.

In one aspect, the calcium source comprises a source of calcium and boron. Various methods for synthetically producing these calcium sources are known in the art. For example, Ditte, Acad. Sci. Paris Coptes rendus 77, 783-785 (1873), describes the formation of lime borates by reaction of Iceland spar (calcite) with a saturated boric acid solution. Kemp, The Chemistry of Borates, Part I, page 70 (1956), describes that an aqueous solution of boric acid kept at 40° C. for 3 weeks deposits a mixture of CaO.3B₂O₃.4H₂O and 2CaO.3B₂O₃.9H₂O. Mellor's Comprehensive Treatise on Inorganic and Theoretical Chemistry, Volume V Part A: Boron-Oxygen Compounds, pages 550-551 (1980) discloses that CaO.3B₂O₃.5H₂O (gowerite) is formed from lime and boric acid in aqueous media at 100° C. Lehmann et al, Zeitshrift fuir Anorganische und Allgemeine Chemie, Volume 346, pages 12-20, (1966), discloses that the formation of gowerite from CaO, H₃BO₃ and water is favored by a relatively high temperature (100° C.), and higher CaO concentration, whereas nobleite formation is predominantly formed in more dilute solutions with lower CaO content and at lower temperature (60° C.). U.S. Pat. No. 5,785,939 to Schubert discloses methods for producing crystalline calcium hexaborate tetrahydrate. All of the references described above are incorporated by reference in their entireties with respect to producing synthetic calcium boron compounds.

In one aspect, the calcium source comprises a calcium borate. Examples of calcium borate include, but are not limited to, Ca₂B₆O₁₁.5H₂O, Ca(BO₂)₂.4H₂O, Ca(B(OH)₄)₂.2H₂O, Ca₂B₂O₅.H₂O, Ca₃B₄O₉.9H₂O, CaO.B₂O₃.6H₂O, CaO.B₂O₃.4H₂O, CaO.3B₂O₃.5H₂O, or CaO.3B₂O₃.4H₂O. In another aspect, the source of calcium comprises a calcium metaborate. Examples of calcium metaborate useful herein include, but are not limited to, CaO.B₂O₃, CaO.B₂O₃.H₂O, CaO.B₂O₃.2H₂O, or any mixture thereof. In one aspect, calcium metaborate distributed by Alfa Aesar or “CadyCal” colemanite manufactured by Fort Cady Minerals Corporation can be used herein. In another aspect, calcium metaborate manufactured by BOR J.S.C. under the trade name Calcium Borate (export grade) can be used as the calcium source.

In certain aspects, the calcium source can be derived form naturally-occurring limestone, which is predominantly calcium carbonate. Depending upon the source of the limestone, the limestone may or may not contain single crystal quartz grains or refractory particles having a particle size less than about 210 μm. If single crystal quartz grains or refractory particles having a particle size greater than about 210 μm are present in the limestone, it is possible to grind the limestone so that the limestone with the single crystal quartz grains or refractory particles have a particle size less than 210 μm.

In another aspect, the calcium source has no single crystal quartz grains or refractory particles. For example, a naturally-occurring calcium source can be purified to remove any single crystal quartz grains or refractory particles. In one aspect, calcium carbonate can be precipitated to remove any single crystal quartz grains or refractory particles. For example, spray-dried precipitated calcium carbonate can be used herein. Methods for producing spray-dried precipitated calcium carbonate are known in the art (see for example U.S. Pat. No. 4,0352,257, which is incorporated by reference).

As described above, it would be desirable to reduce the size and number of stones in the final glass product. This is particularly desirable in certain applications such as, for example, the production of glass sheets for liquid crystal display (LCD). If stones of certain particle size or greater are present in the glass sheet, the sheet is defective and discarded, which adds to the overall costs for the production of the glass sheet. The stones can be derived from various sources during glass manufacturing.

One such source is the presence of single crystal quartz grains or refractory particles present in the batch materials used to make the glass. Thus, by minimizing the size and number of grains or particles in the calcium source, it is possible to produce a glass composition with smaller and fewer stones. In one aspect, the calcium source contains single crystal quartz grains or refractory particles having a particle size less than about 210 μm, less than about 175 μm, less than about 150 μm, less than about 125 μm, or less than about 100 μm. In other aspects, the calcium source contains single crystal quartz grains or refractory particles having a particle size of from about 10 μm to 210 μm, from about 50 μm to 150 μm, from about 75 μm to 125 μm, or from about 10 μm to 100 μm. The size of the single crystal quartz grains or refractory particles present in the calcium source can be measured using techniques known in the art. For example, a sample of the calcium source can be viewed under a polarized-light microscope and the particle size of the grains or particles of any single crystal quartz grains or refractory particles present in the sample can be measured.

In certain aspects, it is possible to use batch materials that possess single crystal quartz grains or refractory particles having a size greater than 210 μm. In one aspect, described herein is a method for producing a glass composition, comprising heating a mixture of glass precursor components for a sufficient time and temperature to melt the components to produce the glass composition, wherein one of the glass precursor components comprises single crystal quartz grains or refractory particles having a particle size greater than about 210 μm, wherein the glass precursor component is not sand, wherein upon heating the single crystal quartz grains or refractory particles the single crystal quartz grains or refractory particles are reduced to a particle size of less than about 210 μm. For example, it is contemplated that limestone possesses single crystal quartz grains or refractory particles having a size greater than 210 μm, wherein the grains or particles have water entrapped within the grain or particle. Upon heating, the grains or particles fracture (e.g., explode) due to the entrapped water to produce smaller particles (i.e., less than 210 μm). It is contemplated that glass precursor with the large grains or particles can be preheated prior to admixing with the other glass precursor components or, in the alternative, it can be admixed with the other glass precursor components to produce an admixture then subsequently heated.

A number of other different components can be used as glass precursor components in combination with the calcium source to produce glass compositions. The term “glass precursor component” as used herein is any compound that upon heating in the presence of oxygen is converted to the corresponding oxide. The term “glass precursor component” also covers an oxide of a compound (e.g., SiO₂ or Al₂O₃) that can be admixed with other glass precursor components prior to heating. A number of different alkali, alkaline earth metal, and transition metals compounds such as, for example, salts and/or oxides can be used as the glass precursor component. Examples of salts include, but are not limited to, carbonates, nitrates, hydroxylates, halides, and the like. It is contemplated that arsenic (e.g., As₂O₃), antimony (e.g., Sb₂O₃), tin (e.g., SnO₂), and any combination thereof can be present in the glass composition. Arsenic, antimony, and tin batch materials are generally used as fining agents to reduce seed formation. In one aspect, the glass precursor component besides the calcium source comprises silicon dioxide, aluminum oxide, boric acid, strontium nitrate, magnesium oxide, or any mixture or combination thereof. In a further aspect, the glass precursor component further comprises an arsenic compound, an antimony compound, a tin compound, or any combination thereof.

The relative amounts of other glass precursor components including the calcium source can vary depending upon the end-use of the glass composition. For example, glasses for LCD substrates are typically hard to melt by using the conventional glass making process. An exemplary LCD glass substrate contains, in weight percent on an oxide basis, of 40-57% SiO₂, 2.0-11% Al₂O₃, 1-16% CaO, 8-21.5% SrO, 14-31.5% BaO, 0-3% MgO, 0-4% B₂O₃ and miscellaneous small amounts of other oxides. In one aspect, the glass precursor component comprises a mixture of silicon dioxide, aluminum oxide, boric acid, strontium nitrate, magnesium oxide, and a calcium metaborate. In another aspect, the glass precursor component comprises a mixture of silicon dioxide, aluminum oxide, boric acid, strontium nitrate, magnesium oxide, and a precipitated calcium carbonate. In each of these aspects, it is contemplated that an arsenic compound, an antimony compound, a tin compound, or any combination thereof can be used as well.

A common glass composition such as, for example, a silicate glass composition, generally contains glass formers, stabilizers, fluxes, colorants, decolorants, fining agents, and the like. Glass formers are oxides that form the structural network of glass, including SiO₂, B₂O₃, P₂O₅, GeO₂, V₂O₅ and As₂O₃. Fluxes are typically Group I alkaline oxides and Group II alkaline earth oxides, the source materials of which in the batch tend to react at a relatively lower temperature in the furnace. Stabilizers are oxides that bring about high chemical resistance to the glass and control the working characteristics of the glass together with the fluxes in forming operations. Common stabilizers include, but are not limited to, alkaline earth metal oxides, PbO, ZnO, and Al₂O₃. Various transitional metal oxides may be introduced into the glass composition as colorants. As decolorants, selenium, cobalt and arsenic may be used to impart colorless transparency to the glass. Fining agents are added to remove seeds in the glass.

Prior to the heating step, the glass precursor components can be mixed in any type of mixer that is conventionally used in glass making industry, including, but not limited to, ribbon, pan, drum and cone type mixers. The commonly used Eirich mixer can be conveniently employed. The mixture is then charged into a glass furnace where it is melted, formed, and optionally fined into the glass material in a manner similar to the conventional glass making process. It is contemplated that the glass precursor components can be mixed in any order prior to heating. In one aspect, all of the glass precursor components are mixed prior to the heating step. In another aspect, one or more glass precursor components are heated to produce a frit, followed by heating the frit in the presence of one or more additional glass precursor components to produce a glass composition. The techniques disclosed in U.S. Published Application No. 2004/0050106, which is incorporated by reference with respect to making and using glass frits, can be used herein.

Any type of furnace can be employed in the heating step in order to melt the mixture of glass precursor components. For example, a pot furnace, a fuel-fired tank furnace, an electric boosted fuel-fired tank furnace, and all-electric tank furnaces of various sizes can be chosen by one of ordinary skill in the art according to the production rate, glass quality and other considerations. In one aspect of the disclosed methods, the heating step can be conducted at from about 1,500 to 1,675° C. In other aspects, the heating step can be conducted at 1,500, 1,525, 1,550, 1,575, 1,600, 1,625, or 1,675° C. The heating step is generally performed at a temperature so that the components used to produce the compositions described herein are melted such that a homogeneous state is produced.

In certain aspects, the glasses can be made using a downdraw process such as, for example, a fusion downdraw process. An example of a suitable fusion process is disclosed in U.S. Pat. No. 4,214,886, which is incorporated by reference herein in its entirety. Other fusion processes, which can be used in the methods disclosed herein, are described in U.S. Pat. Nos. 3,338,696, 3,682,609, 4,102,664, 4,880,453, and U.S. Published Application No. 2005-0001201, which are incorporated by reference herein in their entireties.

Although it is desirable to reduce the number of stones present in the final glass composition or product, it is not as important as the size of the stones. In certain aspects, the methods described herein produce glass compositions wherein the glass compositions possess no stones having a particle size greater than 40 μm, greater than 30 μm, or greater than 20 μm. In another aspect, when a downdraw process is used to make the glass, the glass composition produced by the downdraw process can produce 50 sequential glass sheets having an average number of stones less than 0.05 stones/cubic centimeter, where each sheet has a volume of at least 500 cubic centimeters, wherein the stones are less than 40 μm, less than 30 μm, or less than 20 μm in particle size. In another aspect, 10 stones per pound of glass are produced by the methods described herein.

The methods described herein provide numerous advantages over previous techniques for preparing glass compositions. The methods described herein permit the production of glass compositions with a reduced number of stones having a small particle size. For certain applications, the presence of stones is unacceptable, particularly if the glass is used for an LCD substrate. The methods described herein also permit the consistent production of glass compositions without the addition of other glass precursor components to offset the impurities present in the impure precursor component. For example, if the mined limestone had a certain amount of impurity, other components would have to be added to the glass formulation to produce a glass composition with the appropriate manufacturing or glass attributes. In the case of mined limestone, magnesium oxide is present in varying amounts. Thus, additional magnesium oxide may have to be added to compensate for the inherent variability in magnesium oxide content present in the mined limestone. This is significant for large-scale production of glass, where variable amounts of impurities are present in certain glass precursor components typically used in the art.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1

Several glass compositions were made using the following procedure and the formulations in Tables 1-4. In a one quart ball jar mixer with intensifier bar, 400 gm of glass precursor components were mixed for 3 minutes dry. To the mixture, 0.5% by weight water was added and mixed 3 minutes wet in 1 qt. jar with intensifier bar just before melting. The furnace was preheated to the target temperature plus 100° C. Platinum crucibles were loaded with the mixture of precursor components and covered with Pt covers. The crucibles were loaded into the furnace and heating time commenced once the furnace was closed. The mixture was heated for the time based on the profile in Table A below. The glass was then annealed at 725° C. for 2 hours, the annealer was shut down, and the glass and crucible were allowed to cool to room temperature. A core of 1⅝″ diameter was drilled from the glass. Using a jig, 1/16″ was sliced from the bottom of the meniscus. The remainder of the core was sliced into ¼ discs. A standard stone count was performed on all slices to bottom of the crucible. The stone count was performed using a microscope to examine each slice and physically counting the stones. The number is then multiplied by the volume of the glass slice to compute stones per cubic inch.

TABLE A

| time | temp | time | time adj | Rate |
|---|---|---|---|---|
| (min) | (° C.) | (min) | (min) | (deg/hr) |
| 0 | 1425 | | 0.0 | |
| 30 | 1525 | 30 | 9.0 | 666.67 |
| 132 | 1580 | 102 | 39.6 | 107.84 |
| 192 | 1600 | 60 | 57.6 | 66.67 |
| 210 | 1625 | 18 | 63.0 | 277.78 |
| 246 | 1620 | 36 | 73.8 | −27.78 |
| 250 | 1590 | 4 | 75.0 | −1500.00 |
| 336 | 1575 | 86 | 100.8 | −34.88 |
| 365 | 11620 | 29 | 109.5 | 310.34 |
| 372 | 11620 | 7 | 111.6 | 0.00 |
| 432 | 11320 | | 171.6 | −300.00 |

TABLE 1

| MATERIAL | GRADE | OPER B | OPER B | OPER B | OPER B |
|---|---|---|---|---|---|
| GLASS | | 745DDW | 745DDW | 745AYB | 745AYB |
| CODE | | | | | |
| Sand | BFS | 227.6 | 227.6 | 228.9 | 228.9 |
| Alumina | Alcan C | 58.4 | 58.4 | 58.4 | 58.4 |
| | 716 | | | | |
| Boric acid | Granular | 7.6 | 7.6 | 67.5 | 67.5 |
| | Tech. | | | | |
| Sr-Nitrate | Low-Ba | 5.8 | 5.8 | 5.8 | 5.8 |
| | Grade | | | | |
| Limestone | R-1 | | | 50.8 | 50.8 |
| Magnesia | MCP 9830 | 0.01 | 0.01 | 0.25 | 0.25 |
| Calcium | N-16 | 78.2 | 78.2 | | |
| Borate | | | | | |
| Arsenic Acid | 75% high | 7.3 | 7.3 | 7.26 | 7.26 |
| | purity | | | | |
| Tin Oxide | CF | 0.18 | 0.18 | 0.18 | 0.18 |
| OXIDE | | 385.2 | 385.2 | 419.0 | 419.0 |
| YIELD | | | | | |
| Stones/ln³ | | 347 | 93 | 508 | 311 |

TABLE 2

| MATERIAL | GRADE | OPER B | OPER B | OPER B |
|---|---|---|---|---|
| GLASS CODE | | 745DDY | 745DDY | 745DDY |
| Sand | BFS | 229.5 | 229.5 | 229.5 |
| Alumina | Alcan C 716 | 58.4 | 58.4 | 58.4 |
| Boric acid | Granular Tech. | 7.6 | 7.6 | 7.6 |
| Sr-Nitrate | Low-Ba Grade | 5.8 | 5.8 | 5.8 |
| Limestone | R-1 | | | |
| Magnesia | MCP 9830 | 0.01 | 0.01 | 0.01 |
| Calcium Borate | N-16 | 78.2 | 78.2 | 78.2 |
| Arsenic Acid | 75% high purity | 3.6 | 3.6 | 3.6 |
| Tin Oxide | CF | 0.18 | 0.18 | 0.18 |
| OXIDE YIELD | | 383.5 | 383.5 | 383.5 |
| Stones/ln³ | | 398 | 247 | 276 |

TABLE 3

| MATERIAL | GRADE | OPER B | OPER B | OPER B |
|---|---|---|---|---|
| GLASS CODE | | 745DDY | 745AYB | 745DDZ |
| Sand | BFS | 229.5 | 228.9 | 230.9 |
| Alumina | Alcan C 716 | 58.4 | 58.4 | 58.4 |
| Boric acid | Granular Tech. | 7.6 | 67.5 | 67.5 |
| Sr-Nitrate | Low-Ba Grade | 5.8 | 5.8 | 5.8 |
| Limestone | R-1 | | 50.8 | 50.8 |
| Magnesia | MCP 9830 | 0.01 | 0.25 | 0.25 |
| Calcium Borate | N-16 | 78.2 | | |
| Arsenic Acid | 75% high purity | 3.63 | 7.26 | 3.63 |
| Tin Oxide | CF | 0.18 | 0.18 | 0.18 |
| OXIDE YIELD | | 383.5 | 419.0 | 417.3 |
| Stones/ln³ | | 1571 | 362 | 713 |

TABLE 4

| MATERIAL | GRADE | OPER B | OPER B | OPER B | OPER B |
|---|---|---|---|---|---|
| GLASS | | 745AYB | 745DDZ | 745DDZ | 745DDZ |
| CODE | | | | | |
| Sand | BFS | 228.9 | 230.9 | 230.9 | 230.9 |
| Alumina | Alcan C | 58.4 | 58.4 | 58.4 | 58.4 |
| | 716 | | | | |
| Boric acid | Granular | 67.5 | 67.5 | 67.5 | 67.5 |
| | Tech. | | | | |
| Sr-Nitrate | Low-Ba | 5.8 | 5.8 | 5.8 | 5.8 |
| | Grade | | | | |
| Limestone | R-1 | 50.8 | 50.8 | 50.8 | 50.8 |
| Magnesia | MCP 9830 | 0.25 | 0.3 | 0.3 | 0.3 |
| Calcium | N-16 | | | | |
| Borate | | | | | |
| Arsenic Acid | 75% high | 7.3 | 3.6 | 3.6 | 3.6 |
| | purity | | | | |
| Tin Oxide | CF | 0.18 | 0.18 | 0.2 | 0.2 |
| OXIDE | | 419.0 | 417.3 | 417.3 | 417.3 |
| YIELD | | | | | |
| Stones/ln³ | | | 529 | 366 | 746 |

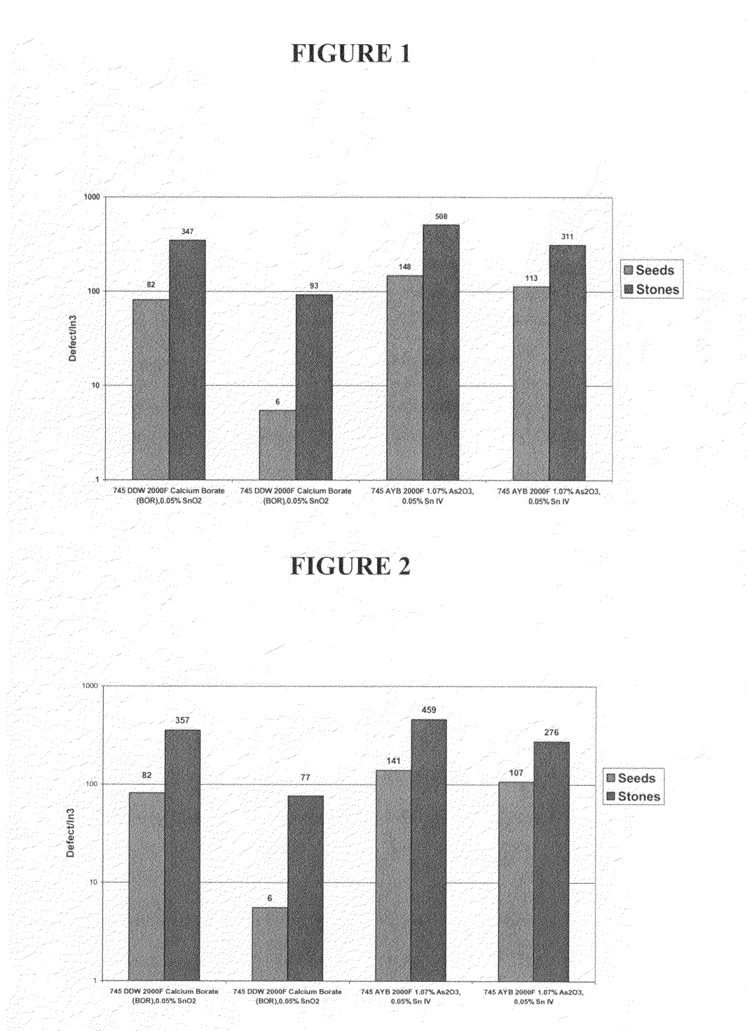

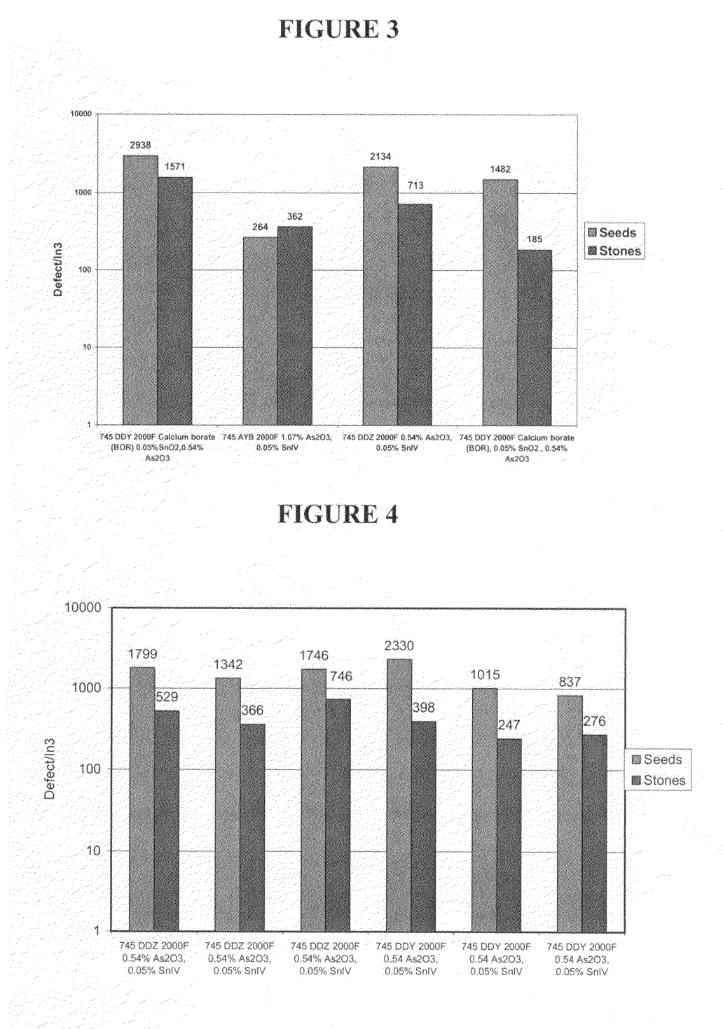

Tables 1-4 and FIGS. 1-4 show the stone and seed defect averages for several glass compositions produced with calcium metaborate manufactured by BOR J.S.C. (identified as sample N-16 in Tables 1-4), substituted for mined limestone when compared to glass compositions prepared with mined limestone as one of the glass precursor components. Referring to Table 1, four batch glass formulations were produced based on the formulations in Table 1. The two batch glass formulations produced by formulation 745 DDW, which contains calcium metaborate, had approximately the same number of seeds/stones or less when compared to two batch Corning EAGLE²⁰⁰⁰™ formulations, 745 AYB, which were not produced with calcium metaborate. Similar results are shown in Tables 2-4, where the number of stones present in glass compositions produced by the methods described herein is comparable or less than batch Corning EAGLE²⁰⁰⁰™ formulations produced with mined limestone.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed:

1. A method for producing a glass composition, comprising heating a mixture of glass precursor components for a sufficient time and temperature to melt the components to produce the glass composition, wherein one of the glass precursor components comprises a calcium source comprising (1) no single crystal quartz grains or refractory particles or (2) single crystal quartz grains or refractory particles having a particle size less than about 210 μm.

2. The method of claim 1, wherein the particle size of the single crystal quartz grains or refractory particles is less than about 150 μm.

3. The method of claim 1, wherein the particle size of the single crystal quartz grains or refractory particles is less than about 100 μm.

4. The method of claim 1, wherein the calcium source comprises ground limestone.

5. The method of claim 1, wherein the calcium source comprises no quartz grains or refractory particles.

6. The method of claim 1, wherein the calcium source comprises spray-dried precipitated calcium carbonate.

7. The method of claim 1, wherein the calcium source comprises a calcium salt, oxide, or a mixture thereof.

8. The method of claim 1, wherein the calcium source comprises calcium hydroxide, calcium carbonate, calcium oxide, calcium nitrate, calcium chloride, or any combination thereof.

9. The method of claim 1, wherein the calcium source comprises a calcium borate.

10. The method of claim 9, wherein the calcium borate comprises Ca₂B₆O₁₁.5H₂O, Ca(BO₂)₂.4H₂O, Ca(B(OH)₄)₂.2H₂O, Ca₂B₂O₅.H₂O, Ca₃B₄O₉.9H₂O, CaO.B₂O₃.6H₂O, CaO.B₂O₃.4H₂O, CaO.3B₂O₃.5H₂O, or CaO.3B₂O₃.4H₂O.

11. The method of claim 1, wherein the calcium source comprises calcium metaborate comprising the formula CaO.B₂O₃, CaO.B₂O₃.H₂O, CaO.B₂O₃.2H₂O, or any mixture thereof.

12. The method of claim 1, wherein the other glass precursor component besides the calcium source comprises silicon dioxide, aluminum oxide, boric acid, strontium nitrate, magnesium oxide, or any mixture or combination thereof.

13. The method of claim 12, wherein the other glass precursor component further comprises an antimony compound, an arsenic compound, a tin compound, or any combination thereof.

14. The method of claim 1, wherein the glass precursor component comprises a mixture of silicon dioxide, aluminum oxide, boric acid, strontium nitrate, magnesium oxide, and a calcium metaborate.

15. The method of claim 14, wherein the glass precursor component further comprises an antimony compound, an arsenic compound, a tin compound, or any combination thereof.

16. The method of claim 1, wherein the glass precursor component comprises a mixture of silicon dioxide, aluminum oxide, boric acid, strontium nitrate, magnesium oxide, and a precipitated calcium carbonate.

17. The method of claim 16, wherein the glass precursor component further comprises an antimony compound, an arsenic compound, a tin compound, or any combination thereof.

18. The method of claim 1, wherein the heating step is conducted at a temperature up to 1,675° C.

19. The method of claim 1, wherein all of the glass precursor components are mixed prior to the heating step.

20. The method of claim 1, wherein after the heating step, the glass composition does not contain any stones having a particle size greater than 40 μm.

21. The method of claim 1, wherein after the heating step, the glass composition does not contain any stones having a particle size greater than 20 μm.

22. The method of claim 1, wherein the method comprises a downdraw process, wherein the downdraw process produces 50 sequential glass sheets having an average number of stones less than 0.05 stones/cubic centimeter, where each sheet has a volume of at least 500 cubic centimeters, wherein the stones are less than 40 μm in size.

23. A method for producing a glass composition, comprising heating a mixture of glass precursor components for a sufficient time and temperature to melt the components to produce the glass composition, wherein after the heating step, the glass composition does not contain any stones having a particle size less greater 40 μm.

24. A method for producing a glass composition by a downdraw process, comprising heating a mixture of glass precursor components for a sufficient time and temperature to melt the components to produce the glass composition, wherein the downdraw process produces 50 sequential glass sheets having an average number of stones less than 0.05 stones/cubic centimeter, where each sheet has a volume of at least 500 cubic centimeters, wherein the stone are less than 40 μm.

25. A method for producing a glass composition, comprising heating a mixture of glass precursor components for a sufficient time and temperature to melt the components to produce the glass composition, wherein one of the glass precursor components comprises single crystal quartz grains or refractory particles having a particle size greater than about 210 μm, wherein the glass precursor component is not sand, wherein upon heating the single crystal quartz grains or refractory particles are reduced to a particle size of less than about 210 μm.

26. The method of claim 25, wherein the glass precursor component comprising the single crystal quartz grains or refractory particles comprises a calcium source.
